(19) United States
(12) Patent Application Publication
(10) Pub. No.: US 2018/0300746 A1
(43) Pub. Date: Oct. 18, 2018

(54) Intelligent Sensor System for Capturing Advertising Impressions from Autonomous Self-Driving Vehicles with Advertising Platforms

(71) Applicant: Alexander Terzian, Boston, MA (US)

(72) Inventor: Alexander Terzian, Boston, MA (US)

(21) Appl. No.: 15/897,788

(22) Filed: Feb. 15, 2018

Related U.S. Application Data
(63) Continuation-in-part of application No. 15/613,190, filed on Jun. 3, 2017.
(60) Provisional application No. 62/484,947, filed on Apr. 13, 2017.

(51) Int. Cl. G06Q 30/02; G06K 9/00; G09F 21/04; G09F 21/18; G06T 7/70

(52) U.S. Cl. CPC G06Q 30/0242; G06K 9/00791; G09F 21/048; G06T 2207/30201; G09F 21/18; G06T 7/70; G06T 2207/30248; G06K 9/00221

(57) ABSTRACT

An intelligent sensor system for capturing and analyzing advertising impressions received from self-driving vehicles displaying external advertising platforms, such as video display signage. The advertising impressions would include pedestrian and vehicles in visible range of the external advertising platform on the self-driving vehicle as it traversed a geographic area. A large fleet of such self-driving vehicles could constantly move between targeted areas, including suburban neighborhoods to obtain a maximum advertising impressions, without the need of a human operator.

### CROSS REFERENCE TO RELATED APPLICATION

This application claims the benefit of U.S. Provisional Patent Application No.: 62/484,947, filed on Apr. 13, 2017 and is a continuation-in-part of U.S. patent application Ser. No. 15/613,190, filed Jun. 3, 2017, the contents of both which are incorporated herein by reference.

### FIELD OF THE INVENTION

The invention relates to an intelligent sensor system for capturing and analyzing advertising impressions received from self-driving vehicles displaying external advertising platforms.

### BACKGROUND OF INVENTION

Evaluating the effectiveness of advertising and marketing strategies and tactics can difficult and costly to obtain. Such evaluation is needed to formulate and implement these strategies and tactics to reach the maximum number of targeted customers, and potential customers, for the minimal amount of expenses. Without constant re-evaluation and control of advertising and marketing strategies, they can lose effectiveness or costs can spiral out of control.

Traditional advertising outlets, such as billboards, printed media (e.g. newspapers, magazines, direct marketing mailers), radio, and television commercials reach broad untargeted audiences, but they suffer from several evaluation and assessment problems: 1) it is difficult to calculate the number of views to specific targeted individuals or groups of individuals; 2) these types of advertisements are costly to produce; 3) these types of advertisements result in overpayment due to a lack of targeting, resulting in a waste of advertising expenditures; and 4) these types of advertisement are difficult to modify quickly to reach an audience that changes in real time.

Newer forms of advertising strategies and tactics on electronic media such as website advertising, mobile device advertising, social media, and e-mail are much easier to track views, less costly to produce, easier to limit to targeted individuals or groups of individuals, and can be modified quickly to reach different audiences in real time. However, these types of media do not reach broad audiences, and often fail to reach customers or potential customers at the edge, or outside of a targeted group.

So, the subject invention is a new tool for evaluating advertising that is cheaper to produce, easy to modify in real time based on audience evaluation, can be tailored to reach specific individuals or groups of individuals, and can reach broad audiences.

The subject invention is an intelligent sensor system for capturing and analyzing advertising impressions received from self-driving vehicles displaying external advertising platforms, that can be used to display ever-changing advertisements. Facial and vehicle recognition software can identify and evaluate those individuals and vehicles with passengers that were in proximity to the vehicle as it traversed a geographic area and displayed a specific advertisement on the video display, to generate advertisement impression metrics. A large fleet of such vehicles could constantly move between targeted areas, including suburban neighborhoods to generate advertisement impression metrics for a large audience, without the need of a human operator.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses an intelligent sensor system for capturing advertising impressions on an autonomous vehicle advertising platform comprising: a self-driving road vehicle containing a computing processor comprising executable software, wherein the processor is communicatively coupled with a data storage device; a first plurality of sensors for capturing data from and monitoring the surrounding environment of the self-driving road vehicle, wherein the first plurality of sensors is communicatively coupled with the computing processor and the data storage device; a second plurality of sensors for capturing data from and monitoring the internal drive systems of the self-driving road vehicle, wherein the second plurality of sensors is communicatively coupled with the computing processor and the data storage device; wherein the data captured from the first and second plurality of sensors is received by the computing processor, the executable software controls the driving functions of the self-driving vehicle; an external video screen for displaying a plurality of advertisements, wherein the external video screen is communicatively coupled with the computing processor and the data storage device; a plurality of intelligent camera sensors for taking images and video along a particular field-of-view around and external to the self-driving vehicle, wherein the plurality of intelligent camera sensors is communicatively coupled with the computing processor and the data storage device; wherein the data captured from the plurality of intelligent camera sensors is received by the computing processor, and the executable software comprises facial recognition software and vehicle recognition software to identify a plurality of individuals and a plurality of vehicles in the particular field-of-view around and external to the self-driving vehicle in real-time; wherein the computing processor and the executable software calculates which advertisements from the plurality of advertisements shown on the external video screen were visible to the identified plurality of individuals and plurality of vehicles based on the time and location of each advertisement in relation to each individual and vehicle, wherein the computing processor and the executable software generates a plurality of advertising impressions of the plurality of advertisements.

The subject invention also discloses an intelligent sensor system for capturing advertising impressions on an autonomous vehicle advertising platform comprising: a self-driving road vehicle containing a computing processor comprising executable software, wherein the processor is communicatively coupled with a data storage device; a first plurality of sensors for capturing data from and monitoring the surrounding environment of the self-driving road vehicle, wherein the first plurality of sensors is communicatively coupled with the computing processor and the data storage device; a second plurality of sensors for capturing data from and monitoring the internal drive systems of the self-driving road vehicle, wherein the second plurality of sensors is communicatively coupled with the computing processor and the data storage device; wherein the data captured from the first and second plurality of sensors is received by the computing processor, the executable software controls the driving functions of the self-driving vehicle; an external video screen for displaying a plurality of advertisements, wherein the external video screen is communicatively coupled with the computing processor and the data storage device; a plurality of intelligent radiation sensors responsive to radiation reflected from objects along a particular field-of-view around and external to the self-driving vehicle, wherein the plurality of intelligent radiation sensors is communicatively coupled with the computing processor and the data storage device; wherein the data captured from the plurality of intelligent radiation sensors is received by the computing processor, and the executable software comprises facial recognition software and vehicle recognition software to identify a plurality of individuals and a plurality of vehicles from the reflected radiation in the particular field-of-view around and external to the self-driving vehicle in real-time; wherein the computing processor and the executable software calculates which advertisements from the plurality of advertisements shown on the external video screen were visible to the identified plurality of individuals and plurality of vehicles based on the time and location of each advertisement in relation to each individual and vehicle, wherein the computing processor and the executable software generates a plurality of advertising impressions of the plurality of advertisements.

In further embodiments of the subject invention, the invention comprises a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling a plurality of self-driving vehicles and external video screens in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring the generated plurality of advertising impressions in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring generated pluralities of advertising impressions from a plurality of self-driving road vehicles in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time, wherein the control server software can configure the advertising displayed on the external video screen in real-time based on the geographic location of the self-driving vehicle.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; wherein the control server comprises executable software for tracking and monitoring the generated plurality of advertising impressions in real time; and further wherein the control server software analyses the advertising impressions to generate optimal routes for the self-driving vehicle.

In further embodiments of the subject invention, the self-driving vehicle can be a land wheeled vehicle selected from the group consisting of: carts, all-terrain vehicles, cars, trucks, platform trucks, flatbed trucks, semi-trailer trucks, buses, minivans, cargo vans, and panel vans.

In further embodiments of the subject invention, the self-driving vehicle can be an aerial drone.

The subject invention also discloses a method for capturing advertising impressions on an autonomous vehicle advertising platform comprising: generating instructions for a self-driving road vehicle to drive down a plurality of roads, wherein the self driving vehicle comprises a computing processor comprising executable software for receiving said instructions, wherein the processor is communicatively coupled with a data storage device; capturing data from and monitoring the surrounding environment of the self-driving road vehicle as it drives down the plurality of roads from a first plurality of sensors, wherein the first plurality of sensors is communicatively coupled with the computing processor and the data storage device; capturing data from and monitoring the internal drive systems of the self-driving road vehicle as it drives down the plurality of roads from a second plurality of sensors, wherein the second plurality of sensors is communicatively coupled with the computing processor and the data storage device; controlling the driving functions of the self-driving vehicle with the data captured from the first and second plurality of sensors received by the computing processor; displaying a plurality of advertisements on an external video screen, wherein the external video screen is communicatively coupled with the computing processor and the data storage device; capturing radiation reflected from objects along a particular field-of-view around and external to the self-driving vehicle with a plurality of intelligent radiation sensors, wherein the plurality of intelligent radiation sensors is communicatively coupled with the computing processor and the data storage device; identifying a plurality of individuals and a plurality of vehicles from the reflected radiation in the particular field-of-view around and external to the self-driving vehicle from the data captured from the plurality of intelligent radiation sensors using facial recognition software and vehicle recognition software on the computing processor; calculating which advertisements from the plurality of advertisements shown on the external video screen were visible to the identified plurality of individuals and plurality of vehicles based on the time and location of each advertisement in relation to each individual and vehicle; and generating a plurality of advertising impressions of the plurality of advertisements.

In further embodiments of the subject invention, the method comprises sending and receiving data files between a communication circuitry in the self-driving vehicle and a remote control server; and controlling the self-driving vehicle and the external video screen in real time with the remote control server.

In further embodiments of the subject invention, the method comprises sending and receiving data files between a communication circuitry in the self-driving vehicle and a remote control server; and controlling a plurality of self-driving vehicles and external video screens in separate geographic locations in real time with the remote control server.

In further embodiments of the subject invention, the method comprises sending and receiving data files between a communication circuitry in the self-driving vehicle and a remote control server; and tracking the generated plurality of advertising impressions in real time with the remote control server.

In further embodiments of the subject invention, the method comprises sending and receiving data files between a communication circuitry in the self-driving vehicle and a remote control server; and generated pluralities of advertising impressions from a plurality of self-driving road vehicles in separate geographic locations in real time with the remote control server.

In further embodiments of the subject invention, the method comprises sending and receiving data files between a communication circuitry in the self-driving vehicle and a remote control server; controlling the self-driving vehicle and the external video screen in real time with the remote control server; and configuring the advertising displayed on the external video screen in real-time based on the geographic location of the self-driving vehicle with the control server.

In further embodiments of the subject invention, the method comprises sending and receiving data files between a communication circuitry in the self-driving vehicle and a remote control server; and tracking the generated plurality of advertising impressions in real time with the remote control server, and analyzing the plurality advertising impressions to generate optimal routes for the self-driving vehicle.

The subject invention discloses an intelligent sensor system for capturing advertising impressions on an autonomous aerial drone advertising platform comprising: a self-flying aerial drone containing a computing processor comprising executable software, wherein the processor is communicatively coupled with a data storage device; a first plurality of sensors for capturing data from and monitoring the surrounding environment of the self-flying aerial drone, wherein the first plurality of sensors is communicatively coupled with the computing processor and the data storage device; a second plurality of sensors for capturing data from and monitoring the internal drive systems of the self-flying aerial drone, wherein the second plurality of sensors is communicatively coupled with the computing processor and the data storage device; wherein the data captured from the first and second plurality of sensors is received by the computing processor, the executable software controls the driving functions of the self-flying aerial drone; an external video screen for displaying a plurality of advertisements, wherein the external video screen is communicatively coupled with the computing processor and the data storage device; a plurality of intelligent camera sensors for taking images and video along a particular field-of-view around and external to the self-flying aerial drone, wherein the plurality of intelligent camera sensors is communicatively coupled with the computing processor and the data storage device; wherein the data captured from the plurality of intelligent camera sensors is received by the computing processor, and the executable software comprises facial recognition software and aerial drone recognition software to identify a plurality of individuals and a plurality of aerial drones in the particular field-of-view around and external to the self-flying aerial drone in real-time; wherein the computing processor and the executable software calculates which advertisements from the plurality of advertisements shown on the external video screen were visible to the identified plurality of individuals and plurality of aerial drones based on the time and location of each advertisement in relation to each individual and aerial drone, wherein the computing processor and the executable software generates a plurality of advertising impressions of the plurality of advertisements.

The subject invention also discloses an intelligent sensor system for capturing advertising impressions on an autonomous aerial drone advertising platform comprising: a self-flying aerial drone containing a computing processor comprising executable software, wherein the processor is communicatively coupled with a data storage device; a first plurality of sensors for capturing data from and monitoring the surrounding environment of the self-flying aerial drone, wherein the first plurality of sensors is communicatively coupled with the computing processor and the data storage device; a second plurality of sensors for capturing data from and monitoring the internal drive systems of the self-flying aerial drone, wherein the second plurality of sensors is communicatively coupled with the computing processor and the data storage device; wherein the data captured from the first and second plurality of sensors is received by the computing processor, the executable software controls the driving functions of the self-flying aerial drone; an external video screen for displaying a plurality of advertisements, wherein the external video screen is communicatively coupled with the computing processor and the data storage device; a plurality of intelligent radiation sensors responsive to radiation reflected from objects along a particular field-of-view around and external to the self-flying aerial drone, wherein the plurality of intelligent radiation sensors is communicatively coupled with the computing processor and the data storage device; wherein the data captured from the plurality of intelligent radiation sensors is received by the computing processor, and the executable software comprises facial recognition software and aerial drone recognition software to identify a plurality of individuals and a plurality of aerial drones from the reflected radiation in the particular field-of-view around and external to the self-flying aerial drone in real-time; wherein the computing processor and the executable software calculates which advertisements from the plurality of advertisements shown on the external video screen were visible to the identified plurality of individuals and plurality of aerial drones based on the time and location of each advertisement in relation to each individual and aerial drone, wherein the computing processor and the executable software generates a plurality of advertising impressions of the plurality of advertisements.

In further embodiments of the subject invention, the invention comprises a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking, monitoring, and controlling the self-flying aerial drones and the external video screen in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking, monitoring, and controlling a plurality of self-flying aerial drones and external video screens in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking and monitoring the generated plurality of advertising impressions in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking and monitoring generated pluralities of advertising impressions from a plurality of self-flying aerial drones in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; and wherein the control server comprises executable software for tracking, monitoring, and controlling the self-flying aerial drones and the external video screen in real time, wherein the control server software can configure the advertising displayed on the external video screen in real-time based on the geographic location of the self-flying aerial drone.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-flying aerial drone; wherein the control server comprises executable software for tracking and monitoring the generated plurality of advertising impressions in real time; and further wherein the control server software analyses the advertising impressions to generate optimal routes for the self-flying aerial drone.

The subject invention also discloses a method for capturing advertising impressions on an autonomous aerial drone advertising platform comprising: generating instructions for a self-flying aerial drone to fly, wherein the self driving aerial drone comprises a computing processor comprising executable software for receiving said instructions, wherein the processor is communicatively coupled with a data storage device; capturing data from and monitoring the surrounding environment of the self-flying aerial drone as it flies from a first plurality of sensors, wherein the first plurality of sensors is communicatively coupled with the computing processor and the data storage device; capturing data from and monitoring the internal drive systems of the self-flying aerial drone as it flies from a second plurality of sensors, wherein the second plurality of sensors is communicatively coupled with the computing processor and the data storage device; controlling the driving functions of the self-flying aerial drone with the data captured from the first and second plurality of sensors received by the computing processor; displaying a plurality of advertisements on an external video screen, wherein the external video screen is communicatively coupled with the computing processor and the data storage device; capturing radiation reflected from objects along a particular field-of-view around and external to the self-flying aerial drone with a plurality of intelligent radiation sensors, wherein the plurality of intelligent radiation sensors is communicatively coupled with the computing processor and the data storage device; identifying a plurality of individuals and a plurality of aerial drones from the reflected radiation in the particular field-of-view around and external to the self-flying aerial drone from the data captured from the plurality of intelligent radiation sensors using facial recognition software and aerial drone recognition software on the computing processor; calculating which advertisements from the plurality of advertisements shown on the external video screen were visible to the identified plurality of individuals and plurality of aerial drones based on the time and location of each advertisement in relation to each individual and aerial drone; and generating a plurality of advertising impressions of the plurality of advertisements.

In further embodiments of the subject invention, the method comprises sending and receiving data files between a communication circuitry in the self-flying aerial drone and a remote control server; and controlling the self-flying aerial drone and the external video screen in real time with the remote control server.

In further embodiments of the subject invention, the method comprises sending and receiving data files between a communication circuitry in the self-flying aerial drone and a remote control server; and controlling a plurality of self-flying aerial drones and external video screens in separate geographic locations in real time with the remote control server.

In further embodiments of the subject invention, the method comprises sending and receiving data files between a communication circuitry in the self-flying aerial drone and a remote control server; and tracking the generated plurality of advertising impressions in real time with the remote control server.

In further embodiments of the subject invention, the method comprises sending and receiving data files between a communication circuitry in the self-flying aerial drone and a remote control server; and generated pluralities of advertising impressions from a plurality of self-flying aerial drones in separate geographic locations in real time with the remote control server.

In further embodiments of the subject invention, the method comprises sending and receiving data files between a communication circuitry in the self-flying aerial drone and a remote control server; controlling the self-flying aerial drone and the external video screen in real time with the remote control server; and configuring the advertising displayed on the external video screen in real-time based on the geographic location of the self-flying aerial drone with the control server.

In further embodiments of the subject invention, the method comprises sending and receiving data files between a communication circuitry in the self-flying aerial drone and a remote control server; and tracking the generated plurality of advertising impressions in real time with the remote control server, and analyzing the plurality advertising impressions to generate optimal routes for the self-flying aerial drone.

The subject invention discloses an intelligent sensor system for capturing advertising impressions on an autonomous watercraft advertising platform comprising: a self-navigating watercraft containing a computing processor comprising executable software, wherein the processor is communicatively coupled with a data storage device; a first plurality of sensors for capturing data from and monitoring the surrounding environment of the self-navigating watercraft, wherein the first plurality of sensors is communicatively coupled with the computing processor and the data storage device; a second plurality of sensors for capturing data from and monitoring the internal drive systems of the self-navigating watercraft, wherein the second plurality of sensors is communicatively coupled with the computing processor and the data storage device; wherein the data captured from the first and second plurality of sensors is received by the computing processor, the executable software controls the driving functions of the self-navigating watercraft; an external video screen for displaying a plurality of advertisements, wherein the external video screen is communicatively coupled with the computing processor and the data storage device; a plurality of intelligent camera sensors for taking images and video along a particular field-of-view around and external to the self-navigating watercraft, wherein the plurality of intelligent camera sensors is communicatively coupled with the computing processor and the data storage device; wherein the data captured from the plurality of intelligent camera sensors is received by the computing processor, and the executable software comprises facial recognition software and watercraft recognition software to identify a plurality of individuals and a plurality of watercrafts in the particular field-of-view around and external to the self-navigating watercraft in real-time; wherein the computing processor and the executable software calculates which advertisements from the plurality of advertisements shown on the external video screen were visible to the identified plurality of individuals and plurality of watercrafts based on the time and location of each advertisement in relation to each individual and watercraft, wherein the computing processor and the executable software generates a plurality of advertising impressions of the plurality of advertisements.

The subject invention also discloses an intelligent sensor system for capturing advertising impressions on an autonomous watercraft advertising platform comprising: a self-navigating watercraft containing a computing processor comprising executable software, wherein the processor is communicatively coupled with a data storage device; a first plurality of sensors for capturing data from and monitoring the surrounding environment of the self-navigating watercraft, wherein the first plurality of sensors is communicatively coupled with the computing processor and the data storage device; a second plurality of sensors for capturing data from and monitoring the internal drive systems of the self-navigating watercraft, wherein the second plurality of sensors is communicatively coupled with the computing processor and the data storage device; wherein the data captured from the first and second plurality of sensors is received by the computing processor, the executable software controls the driving functions of the self-navigating watercraft; an external video screen for displaying a plurality of advertisements, wherein the external video screen is communicatively coupled with the computing processor and the data storage device; a plurality of intelligent radiation sensors responsive to radiation reflected from objects along a particular field-of-view around and external to the self-navigating watercraft, wherein the plurality of intelligent radiation sensors is communicatively coupled with the computing processor and the data storage device; wherein the data captured from the plurality of intelligent radiation sensors is received by the computing processor, and the executable software comprises facial recognition software and watercraft recognition software to identify a plurality of individuals and a plurality of watercrafts from the reflected radiation in the particular field-of-view around and external to the self-navigating watercraft in real-time; wherein the computing processor and the executable software calculates which advertisements from the plurality of advertisements shown on the external video screen were visible to the identified plurality of individuals and plurality of watercrafts based on the time and location of each advertisement in relation to each individual and watercraft, wherein the computing processor and the executable software generates a plurality of advertising impressions of the plurality of advertisements.

In further embodiments of the subject invention, the invention comprises a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking, monitoring, and controlling the self-navigating watercrafts and the external video screen in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking, monitoring, and controlling a plurality of self-navigating watercrafts and external video screens in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking and monitoring the generated plurality of advertising impressions in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking and monitoring generated pluralities of advertising impressions from a plurality of self-navigating watercrafts in separate geographic locations in real time.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; and wherein the control server comprises executable software for tracking, monitoring, and controlling the self-navigating watercrafts and the external video screen in real time, wherein the control server software can configure the advertising displayed on the external video screen in real-time based on the geographic location of the self-navigating watercraft.

In further embodiments of the subject invention, the invention comprises a communication circuitry to bi-directionally send and receive data files between a communication circuitry to bi-directionally send and receive data files between a control server and the computing processor, the data storage device, the first plurality of sensors, the second plurality of sensors, the plurality of intelligent camera sensors, and the external video screen of the self-navigating watercraft; wherein the control server comprises executable software for tracking and monitoring the generated plurality of advertising impressions in real time; and further wherein the control server software analyses the advertising impressions to generate optimal routes for the self-navigating watercraft.

The subject invention also discloses a method for capturing advertising impressions on an autonomous watercraft advertising platform comprising: generating instructions for a self-navigating watercraft, wherein the self driving watercraft comprises a computing processor comprising executable software for receiving said instructions, wherein the processor is communicatively coupled with a data storage device; capturing data from and monitoring the surrounding environment of the self-navigating watercraft from a first plurality of sensors, wherein the first plurality of sensors is communicatively coupled with the computing processor and the data storage device; capturing data from and monitoring the internal drive systems of the self-navigating watercraft from a second plurality of sensors, wherein the second plurality of sensors is communicatively coupled with the computing processor and the data storage device; controlling the driving functions of the self-navigating watercraft with the data captured from the first and second plurality of sensors received by the computing processor; displaying a plurality of advertisements on an external video screen, wherein the external video screen is communicatively coupled with the computing processor and the data storage device; capturing radiation reflected from objects along a particular field-of-view around and external to the self-navigating watercraft with a plurality of intelligent radiation sensors, wherein the plurality of intelligent radiation sensors is communicatively coupled with the computing processor and the data storage device; identifying a plurality of individuals and a plurality of watercrafts from the reflected radiation in the particular field-of-view around and external to the self-navigating watercraft from the data captured from the plurality of intelligent radiation sensors using facial recognition software and watercraft recognition software on the computing processor; calculating which advertisements from the plurality of advertisements shown on the external video screen were visible to the identified plurality of individuals and plurality of watercrafts based on the time and location of each advertisement in relation to each individual and watercraft; and generating a plurality of advertising impressions of the plurality of advertisements.

In further embodiments of the subject invention, the method comprises sending and receiving data files between a communication circuitry in the self-navigating watercraft and a remote control server; and controlling the self-navigating watercraft and the external video screen in real time with the remote control server.

In further embodiments of the subject invention, the method comprises sending and receiving data files between a communication circuitry in the self-navigating watercraft and a remote control server; and controlling a plurality of self-navigating watercrafts and external video screens in separate geographic locations in real time with the remote control server.

In further embodiments of the subject invention, the method comprises sending and receiving data files between a communication circuitry in the self-navigating watercraft and a remote control server; and tracking the generated plurality of advertising impressions in real time with the remote control server.

In further embodiments of the subject invention, the method comprises sending and receiving data files between a communication circuitry in the self-navigating watercraft and a remote control server; and generated pluralities of advertising impressions from a plurality of self-navigating watercrafts in separate geographic locations in real time with the remote control server.

In further embodiments of the subject invention, the method comprises sending and receiving data files between a communication circuitry in the self-navigating watercraft and a remote control server; controlling the self-navigating watercraft and the external video screen in real time with the remote control server; and configuring the advertising displayed on the external video screen in real-time based on the geographic location of the self-navigating watercraft with the control server.

In further embodiments of the subject invention, the method comprises sending and receiving data files between a communication circuitry in the self-navigating watercraft and a remote control server; and tracking the generated plurality of advertising impressions in real time with the remote control server, and analyzing the plurality advertising impressions to generate optimal routes for the self-navigating watercraft.

In further embodiments of the subject invention, the control server monitors the location and displayed advertisements on the external video screen platform in real-time.

In additional embodiments of the subject invention, control server monitors and controls a plurality of self-driving road vehicle, aerial drone, or watercraft in separate geographic locations.

In other embodiments of the subject invention, the control server software can configure the advertising displayed on the external video screen platform in real-time based on the geographic location of the self-driving vehicle, aerial drone, or water craft.

In embodiments of the subject invention, the control server software can configure the advertising displayed on the external video screen platform in real-time based on the time.

In additional embodiments of the subject invention, the control server software can analysis and configure the advertising displayed on the external video screen platform in real-time to generate optimal routes for the advertising campaign.

In further embodiments of the subject invention, the self-driving vehicle can be any land wheeled vehicle.

In other embodiments of the subject invention, the self-driving vehicle can be an aerial drone.

In further embodiments of the subject invention, the self-driving vehicle can be a land wheeled vehicle selected from the group consisting of: carts, all-terrain vehicles, cars, trucks, platform trucks, flatbed trucks, semi-trailer trucks, buses, minivans, cargo vans, panel vans, utility vehicle, sport utility vehicle, golf cart, bus, minibus, ambulance, school bus, delivery truck, motor home, shuttle bus, fire truck, flatbed truck, trailer, fifth wheel trailer, caravan, armored truck, dump truck, garbage truck and a tractor.

In other embodiments of the subject invention, the self-driving vehicle can be a water vessel, selected from the group consisting of: boats, yachts, ships, jet-skis®, or other personal watercraft.

In other embodiments of the subject invention, the plurality of cameras comprise facial recognition software to analyze captures images of individuals in close proximity to the self-driving vehicle to estimate the audience for a displayed advertisement.

In further embodiments of the subject invention, the plurality of cameras comprise facial recognition software to analyze captures images of individuals in close proximity to the self-driving vehicle to alter displayed advertisements on the external video screen platform in real time.

In embodiments of the subject invention, the terms “substantial” or “substantially” are defined as at least close to (and can include) a given value or state, as understood by a person of ordinary skill in the art. In one embodiment, the terms “substantial” or “substantially” refers to ranges within 10%, preferably within 5%, more preferably within 1%, and most preferably within 0.1% of the given value or state being specified.

There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates one embodiment of a self-driving truck with a video signage advertising platform on the side of the truck.

FIG. 2 illustrates another embodiment of a self-driving truck with a video signage advertising platform on the top of the truck.

FIG. 3 illustrates one embodiment of a self-driving bus with a video signage advertising platform on the top of the bus.

FIG. 4 illustrates another embodiment of a self-driving bus with a video signage advertising platform on the top of the bus.

FIG. 5 illustrates one embodiment of a self-driving van with a video signage advertising platform on the side of the van.

FIG. 6 illustrates another embodiment of a self-driving van with a video signage advertising platform on the side of the van.

FIG. 7 illustrates another embodiment of a self-driving van with a video signage advertising platform on the top of the van.

FIG. 8 illustrates another embodiment of a self-driving van with a video signage advertising platform on the front of the van.

FIG. 9 illustrates another embodiment of a self-driving van with a video signage advertising platform on the top of the van.

FIG. 10 illustrates another embodiment of a self-driving van with a video signage advertising platform on the rear of the van.

FIG. 11 illustrates an embodiment of a self-driving aerial drone with a video signage advertising platform.

FIG. 12 illustrates an embodiment of a diagram of a self-driving vehicle capturing images of individuals around the vehicle.

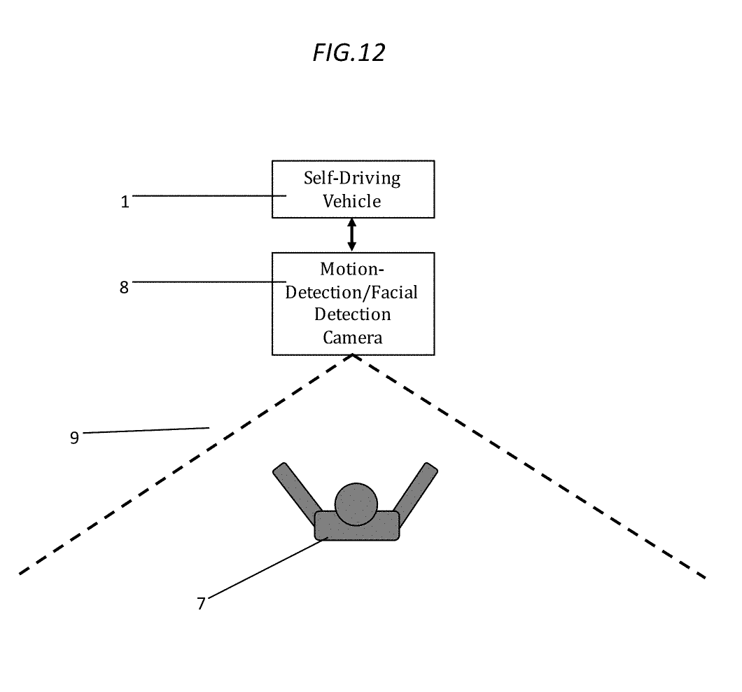

### DETAILED DESCRIPTION OF THE EMBODIMENTS

While several variations of the present invention have been illustrated by way of example in particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

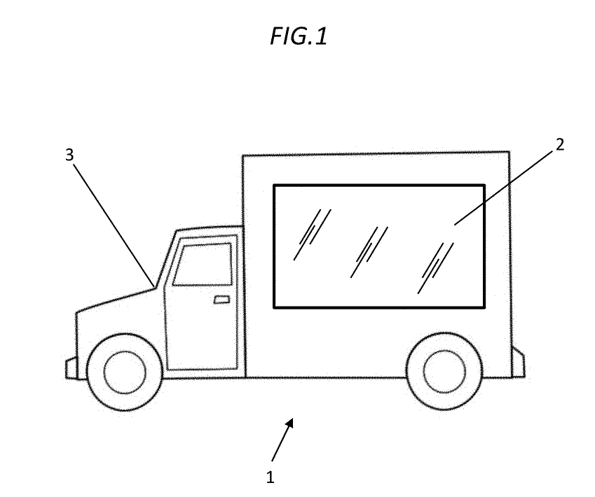

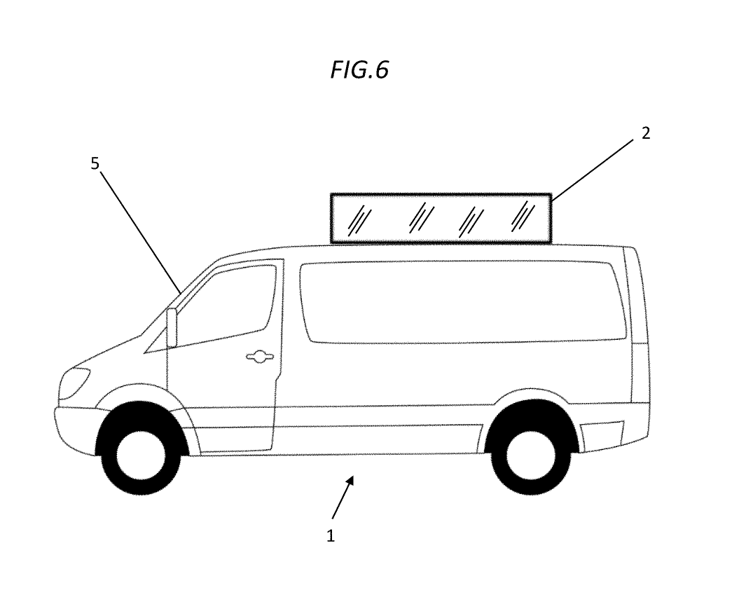

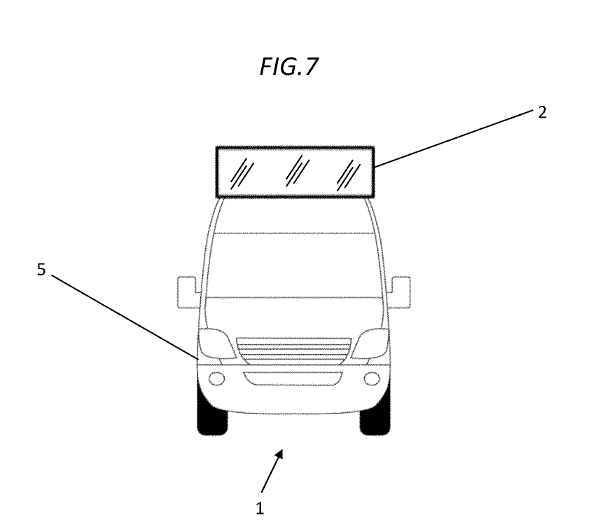

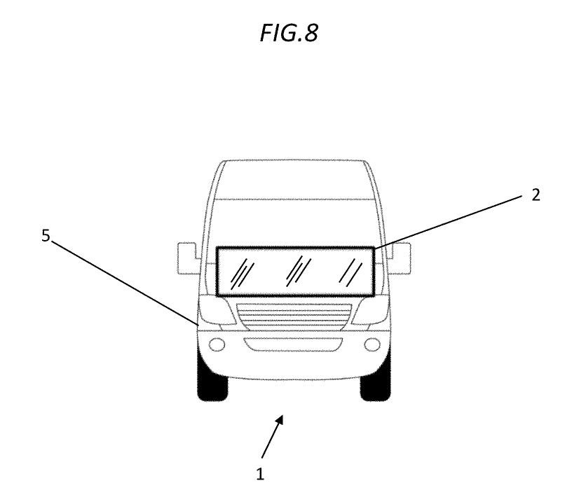

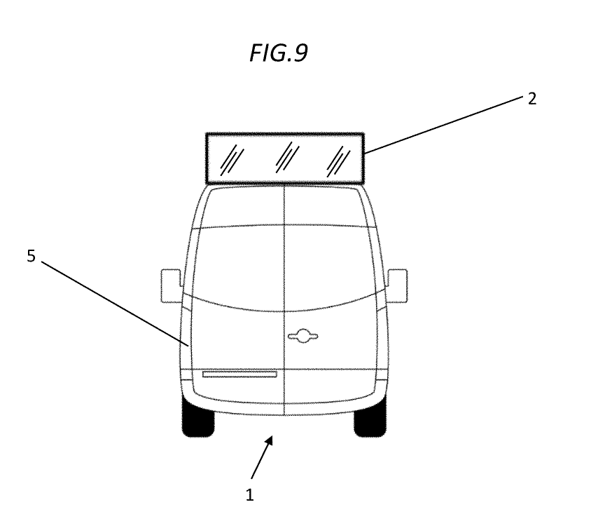

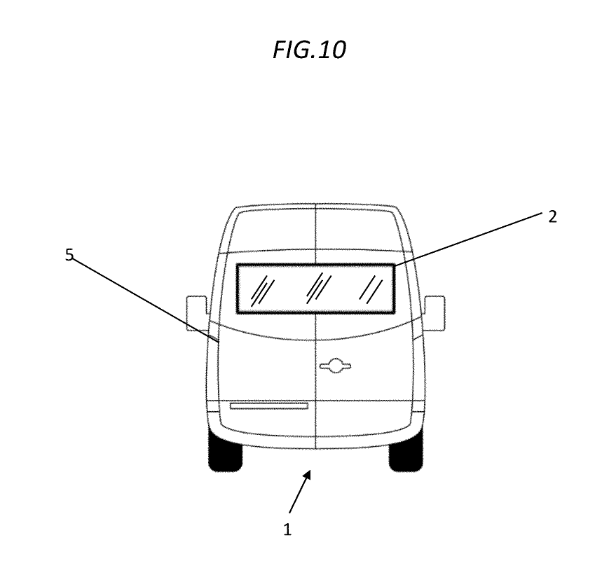

As illustrated in FIGS. 1-11, the subject invention is an intelligent sensor system for capturing and analyzing advertising impressions received from autonomous self-driving vehicles 1 with an advertising platform, such as large video signage 2, that can be used to display ever-changing advertisements.

The audiences of such advertisements include those individuals 7 in proximity to the autonomous vehicle 1 as it traverses a geographic area. Each vehicle 1 contains a plurality of cameras 8 with facial recognition software to analyze captured 9 images of individuals 7 and vehicles in close proximity to the vehicle 1. Based on the facial recognition, age, gender, the software interface program may alter displayed advertisements in real time. These facial recognition cameras 8 calculate the number of audience exposures to a given advertisement on the video signage 2, to generate advertisement impression metrics. A large fleet of such vehicles 1 constantly moves on pre-programmed routes between targeted areas, including suburban neighborhoods, to reach a maximum audience, without the need of a human operator.

The invention includes a software program that interfaces with the plurality of self-driving vehicles 1, for monitoring and controlling the vehicles 1 and the advertising platform. The software includes real time tracking of all vehicles 1. The software can configure an advertising campaign for display on the advertising platforms on each vehicle 1 for certain geographic areas, defined times, and frequency of displayed advertisements.

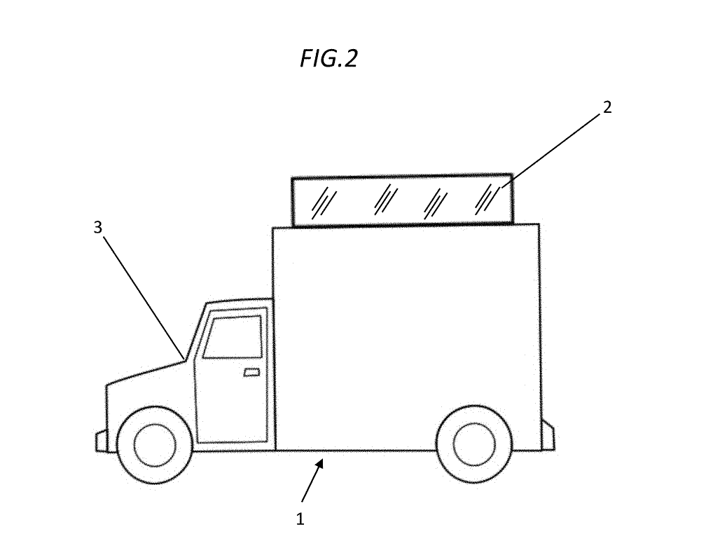

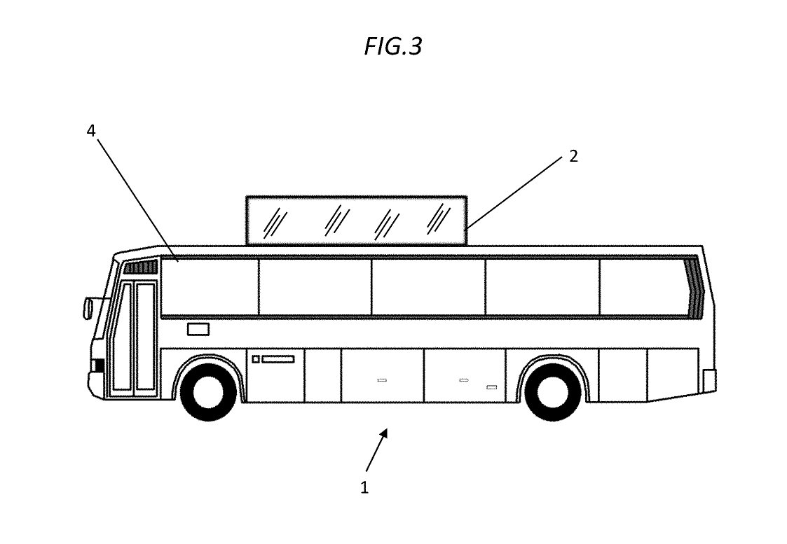

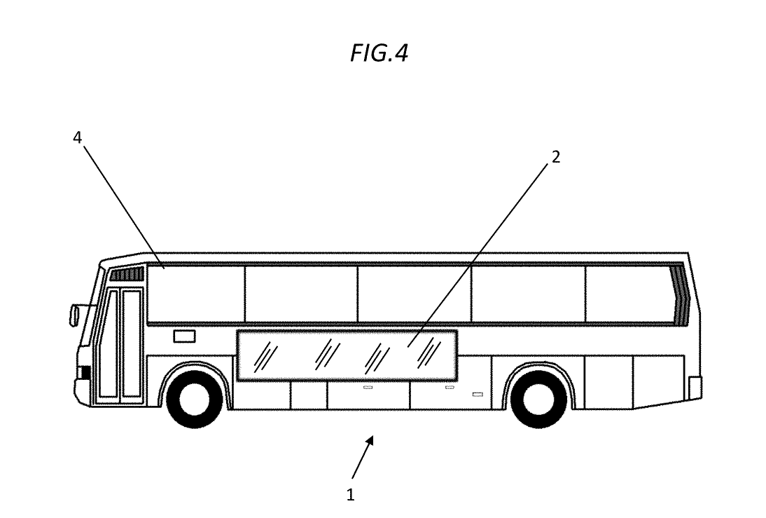

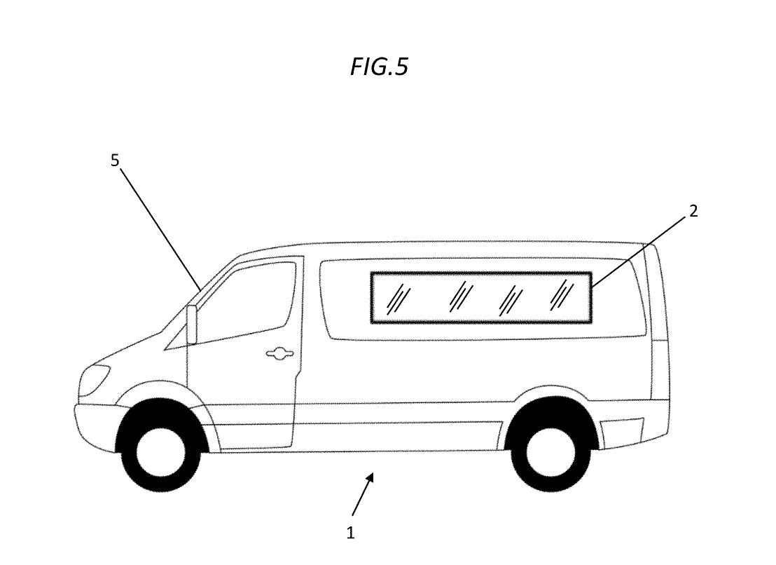

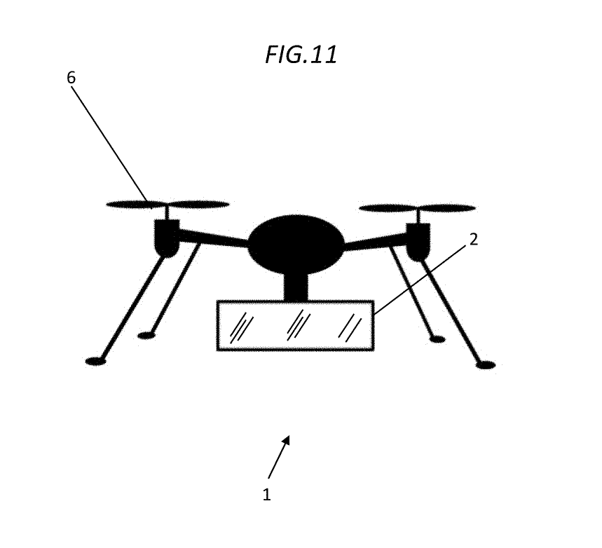

In embodiments of the subject invention, the self-driving vehicle 1 can be any land wheeled vehicle or drone, such as a delivery truck 3, illustrated in FIGS. 1 and 2; a city bus 4, as illustrated in FIGS. 3 and 4, a delivery van 5, as illustrated in FIGS. 5-10, or an aerial drone 6, as illustrated in FIG. 11.

In further embodiments of the subject invention, the vehicle 1 contains a plurality of sensors capture and/or analyze the surrounding environment to permit the vehicle 1 to navigate. The environmental sensors may include, but is not limited to: global positioning system (GPS), satellite receivers, wireless transmitters/receivers, radio transmitters/receivers, RADAR systems, infrared sensors, ultrasound sensors, laser distance finders, accelerometers, inertial measurement units, gyroscopes, compasses, motions sensors, and a plurality of cameras. In further embodiments of the subject invention, the vehicle 1 may contain a plurality of sensors to monitor internal systems, including, but not limited to: engine monitors, fuel gauges, oil levels, oil temperature, tire pressure, and external lights.

In additional embodiments of the subject invention, the software program interfaces with the vehicle's computer control system, the plurality of vehicle sensors, and the vehicle advertising platforms via a communications satellite such as a GPS, a geostationary (GEO) satellite, medium earth orbit (MEO) satellite, or low earth orbit (LEO) satellite, or via a terrestrial wireless network. The wireless network can be a cellular network, such as 3G cellular communication, such as CDMA, EVDO, GSM/GPRS, or 4G cellular communication, such as WiMAX or LTE. The wireless network can be a Wi-Fi or other short range radio network, such as or Bluetooth®. The real time location and activity of each self-driving vehicle 1 may be tracked with a Global Navigation Satellite System (GNSS) such as GPS.

In other embodiments of the subject invention, the software platform can collect and analysis the locations, movements, and activity of the self-driving vehicles 1, and analysis the efficiency of advertisements displayed on the video signage 2 to generate optimal routes for certain advertising campaigns. For examples, certain advertisements displayed at certain times, and/or certain locations may product higher customer contact and sales with the advertiser. By analyzing this data, the routes of the vehicles 1 and the video displays 2 can be coordinated to display to broad and targeted audiences.

In further embodiments of the subject invention, the plurality of cameras 8 around the self-driving vehicle 1 may capture 9 a plurality of images of the environment of the vehicle, and people 7 around the vehicle. The camera 8 may take images or video. The cameras 8 may be multidirectional cameras, cameras with a 360 degree view, rotating cameras, or stereo optic cameras. In embodiments of the subject invention, the plurality of cameras 8 are coupled to the vehicle's vision system which analyzes captured images in order to identify objects in the environment of autonomous neighborhood vehicle that could include traffic signals, traffic signs, other vehicles 1, pedestrians, bicycles, animals, road boundaries, and any other obstacles.

In embodiments of the subject invention, the self-driving vehicles 1 may contain adaptive motion sensors to determine movement of and around the vehicle 1.

In further embodiments of the subject invention, the vehicle's propulsion system can be an engine connected to a transmission and wheels. The engine could be any combination of an internal combustion engine, an electric motor, a hybrid electric/gas engine, a steam engine, a solar powered engine, or other types of engines. The energy source for the engine self-driving vehicle includes, but is not limited to: gasoline, diesel, petroleum-based fuels, propane, compressed gas-based fuels, ethanol, solar panels, and batteries.

The software program that interfaces with the plurality of self-driving vehicles 1 may run on multiple host servers; local, regional and national databases residing within the host servers. The host servers would contain means for uploading data from the plurality of self-driving vehicles 1; means for organizing all the uploaded data into the local, regional and national databases; means for running specific search queries from the self-driving vehicles 1 on the databases.

The computer control system of the self-driving vehicles 1 may contain a processor, a memory storage, and control software, all communicatively coupled with the plurality of environmental sensors, internal monitoring sensors, the advertising platform, and the external software program that interfaces with the plurality of self-driving vehicles 1. The computer control system of the self-driving vehicles 1 may also be communicatively coupled with components to control vehicle driving, including, but not limited to: acceleration unit, braking unit, steering unit, a vision system, a temperature control unit, an obstacle avoidance system, and a navigation system.

The host servers and the computer control systems for the vehicles 1 may include communication devices (such as a bus), a CPU/processor, a main operating memory, and a storage memory, both communicatively coupled with the plurality of environmental sensors, internal monitoring sensors, the advertising platform, and the external software program that interfaces with the plurality of self-driving vehicles 1. The host servers and the computer control system of the self-driving vehicles 1 may also be communicatively coupled with components to control vehicle driving, including, but not limited to: acceleration unit, braking unit, steering unit, a vision system, a temperature control unit, an obstacle avoidance system, and a navigation system.

Embodiments of the CPU/processor may include processors, microprocessors, multi-core processors, microcontrollers, system-on-chips, field programmable gate arrays (FPGA), application specific integrated circuits (ASIC), application specific instruction-set processors (ASIP), or graphics processing units (GPU). The host servers and the computer control systems for the vehicles store computer retrievable information and software executable instructions and may include solid state, magnetic, or optical recording mediums. Embodiments of an input terminal of the mobile computing devices may include a keyboard, a mouse, a pen, a microphone combined with voice recognition software, a camera, a multi-point touch screen, a bar code scanner, or a SKU scanner. In embodiments of the subject invention, the underlying architecture of the system may be implemented using one or more computer programs, each of which may execute under the control of an operating system, such as Windows, OS2, DOS, AIX, UNIX, MAC OS, iOS, ChromeOS, Android, and Windows Phone or CE.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. An intelligent sensor system for capturing advertising impressions on an autonomous vehicle advertising platform, the system comprising:
a self-driving road vehicle containing a computing processor comprising executable software, wherein the processor is communicatively coupled with a data storage device;
a first plurality of sensors for capturing data from and monitoring the surrounding environment of the self-driving road vehicle, wherein the first plurality of sensors is communicatively coupled with the computing processor and the data storage device;
a second plurality of sensors for capturing data from and monitoring the internal drive systems of the self-driving road vehicle, wherein the second plurality of sensors is communicatively coupled with the computing processor and the data storage device;
wherein the data captured from the first and second plurality of sensors is received by the computing processor, the executable software controls the driving functions of the self-driving vehicle;
an external video screen for displaying a plurality of advertisements, wherein the external video screen is communicatively coupled with the computing processor and the data storage device;
a plurality of intelligent camera sensors for taking images and video along a particular field-of-view around and external to the self-driving vehicle, wherein the plurality of intelligent camera sensors is communicatively coupled with the computing processor and the data storage device;
wherein the data captured from the plurality of intelligent camera sensors is received by the computing processor, and the executable software comprises facial recognition software and vehicle recognition software to identify a plurality of individuals and a plurality of vehicles in the particular field-of-view around and external to the self-driving vehicle in real-time;
wherein the computing processor and the executable software calculates which advertisements from the plurality of advertisements shown on the external video screen were visible to the identified plurality of individuals and plurality of vehicles based on the time and location of each advertisement in relation to each individual and vehicle, wherein the computing processor and the executable software generates a plurality of advertising impressions of the plurality of advertisements.

2. An intelligent sensor system for capturing advertising impressions on an autonomous vehicle advertising platform comprising:
a self-driving road vehicle containing a computing processor comprising executable software, wherein the processor is communicatively coupled with a data storage device;
a first plurality of sensors for capturing data from and monitoring the surrounding environment of the self-driving road vehicle, wherein the first plurality of sensors is communicatively coupled with the computing processor and the data storage device;
a second plurality of sensors for capturing data from and monitoring the internal drive systems of the self-driving road vehicle, wherein the second plurality of sensors is communicatively coupled with the computing processor and the data storage device;
wherein the data captured from the first and second plurality of sensors is received by the computing processor, the executable software controls the driving functions of the self-driving vehicle;
an external video screen for displaying a plurality of advertisements, wherein the external video screen is communicatively coupled with the computing processor and the data storage device;
a plurality of intelligent radiation sensors responsive to radiation reflected from objects along a particular field-of-view around and external to the self-driving vehicle, wherein the plurality of intelligent radiation sensors is communicatively coupled with the computing processor and the data storage device;
wherein the data captured from the plurality of intelligent radiation sensors is received by the computing processor, and the executable software comprises facial recognition software and vehicle recognition software to identify a plurality of individuals and a plurality of vehicles from the reflected radiation in the particular field-of-view around and external to the self-driving vehicle in real-time;
wherein the computing processor and the executable software calculates which advertisements from the plurality of advertisements shown on the external video screen were visible to the identified plurality of individuals and plurality of vehicles based on the time and location of each advertisement in relation to each individual and vehicle, wherein the computing processor and the executable software generates a plurality of advertising impressions of the plurality of advertisements.

3. The intelligent sensor system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time.

4. The intelligent sensor system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling a plurality of self-driving vehicles and external video screens in separate geographic locations in real time.

5. The intelligent sensor system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring the generated plurality of advertising impressions in real time.

6. The intelligent sensor system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking and monitoring generated pluralities of advertising impressions from a plurality of self-driving road vehicles in separate geographic locations in real time.

7. The intelligent sensor system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; and wherein the control server comprises executable software for tracking, monitoring, and controlling the self-driving vehicles and the external video screen in real time, wherein the control server software can configure the advertising displayed on the external video screen in real-time based on the geographic location of the self-driving vehicle.

8. The intelligent sensor system of claim 1, further comprising a communication circuitry to bi-directionally send and receive data files between a control server and the computing processor, the data storage device, the first plurality of sensors, the second plurality of sensors, the plurality of intelligent camera sensors, and the external video screen of the self-driving road vehicle; wherein the control server comprises executable software for tracking and monitoring the generated plurality of advertising impressions in real time; and further wherein the control server software analyses the advertising impressions to generate optimal routes for the self-driving vehicle.

9. The intelligent sensor system of claim 1; wherein the self-driving vehicle comprises a land wheeled vehicle selected from the group consisting of: carts, all-terrain vehicles, cars, trucks, platform trucks, flatbed trucks, semi-trailer trucks, buses, minivans, cargo vans, and panel vans.

10. The intelligent sensor system of claim 1, wherein the self-driving vehicle is an aerial drone.

11. A method for capturing advertising impressions on an autonomous vehicle advertising platform comprising:
generating instructions for a self-driving road vehicle to drive down a plurality of roads, wherein the self driving vehicle comprises a computing processor comprising executable software for receiving said instructions, wherein the processor is communicatively coupled with a data storage device;
capturing data from and monitoring the surrounding environment of the self-driving road vehicle as it drives down the plurality of roads from a first plurality of sensors, wherein the first plurality of sensors is communicatively coupled with the computing processor and the data storage device;
capturing data from and monitoring the internal drive systems of the self-driving road vehicle as it drives down the plurality of roads from a second plurality of sensors, wherein the second plurality of sensors is communicatively coupled with the computing processor and the data storage device;
controlling the driving functions of the self-driving vehicle with the data captured from the first and second plurality of sensors received by the computing processor;
displaying a plurality of advertisements on an external video screen, wherein the external video screen is communicatively coupled with the computing processor and the data storage device;
capturing radiation reflected from objects along a particular field-of-view around and external to the self-driving vehicle with a plurality of intelligent radiation sensors, wherein the plurality of intelligent radiation sensors is communicatively coupled with the computing processor and the data storage device;
identifying a plurality of individuals and a plurality of vehicles from the reflected radiation in the particular field-of-view around and external to the self-driving vehicle from the data captured from the plurality of intelligent radiation sensors using facial recognition software and vehicle recognition software on the computing processor;
calculating which advertisements from the plurality of advertisements shown on the external video screen were visible to the identified plurality of individuals and plurality of vehicles based on the time and location of each advertisement in relation to each individual and vehicle; and
generating a plurality of advertising impressions of the plurality of advertisements.

12. The method of claim 11, further comprising sending and receiving data files between a communication circuitry in the self-driving vehicle and a remote control server; and controlling the self-driving vehicle and the external video screen in real time with the remote control server.

13. The method of claim 11, further comprising sending and receiving data files between a communication circuitry in the self-driving vehicle and a remote control server; and controlling a plurality of self-driving vehicles and external video screens in separate geographic locations in real time with the remote control server.

14. The method of claim 11, further comprising sending and receiving data files between a communication circuitry in the self-driving vehicle and a remote control server; and tracking the generated plurality of advertising impressions in real time with the remote control server.

15. The method of claim 11, further comprising sending and receiving data files between a communication circuitry in the self-driving vehicle and a remote control server; and generated pluralities of advertising impressions from a plurality of self-driving road vehicles in separate geographic locations in real time with the remote control server.

16. The method of claim 11, further comprising sending and receiving data files between a communication circuitry in the self-driving vehicle and a remote control server; controlling the self-driving vehicle and the external video screen in real time with the remote control server; and configuring the advertising displayed on the external video screen in real-time based on the geographic location of the self-driving vehicle with the control server.

17. The method of claim 11, further comprising sending and receiving data files between a communication circuitry in the self-driving vehicle and a remote control server; and tracking the generated plurality of advertising impressions in real time with the remote control server, and analyzing the plurality advertising impressions to generate optimal routes for the self-driving vehicle.

18. The method of claim 11, wherein the self-driving vehicle comprises a land wheeled vehicle selected from the group consisting of: carts, all-terrain vehicles, cars, trucks, platform trucks, flatbed trucks, semi-trailer trucks, buses, minivans, cargo vans, and panel vans.

19. The method of claim 11, wherein the self-driving vehicle is an aerial drone.
